(19) United States
(12) Patent Application Publication
(10) Pub. No.: US 2011/0011791 A1
(43) Pub. Date: Jan. 20, 2011

(54) FILTER DEVICE AND METHOD

(75) Inventors: Kyle Thomas Naylor, Midland (CA); Daniel Harry George Williams, Perkinsfield (CA)

Correspondence Address: BARNES & THORNBURG LLP, P.O. Box 2786, CHICAGO, IL, 60690-2786, US

(73) Assignee: INDUSTRIAL FILTER MANUFACTURING LIMITED, Penetanguishene, ON (CA)

(21) Appl. No.: 12/920,952

(22) PCT Filed: Mar. 4, 2009
(86) PCT No.: PCT/CA09/00258

§ 371 Date: Sep. 3, 2010

Related U.S. Application Data
(60) Provisional application No. 61/064,429, filed on Mar. 5, 2008.

(51) Int. Cl. B01D 29/13; B01D 35/30

(52) U.S. Cl. 210/448; 210/452

(57) ABSTRACT

A filter assembly comprises a housing having a first open end, a first closed end, an inlet, and an outlet; a filter support, the filter support having a first permeable support portion and a second permeable support portion nested within the first permeable support portion, the filter support being seated within the housing between the inlet and the outlet; a filter element having a second open end and a second closed end, the filter element being reversed upon itself and positioned between the first and second permeable support portions to form concentrically disposed inner and outer filtering surfaces, the first and second permeable support portions having substantially equal surface area.

### REFERENCE TO COPENDING APPLICATIONS

The entire subject matter of U.S. Provisional application 61/064,429, filed Mar. 5, 2008 and entitled FILTER DEVICE AND METHOD is incorporated herein by reference. The applicants claim priority benefit under Title 35, United States Code, Section 119 of the above application.

### BACKGROUND OF THE INVENTION

1. Field of the Invention

The present invention relates to filter units and methods of filtering.

2. Description of the Related Art

In filter units for industrial operations, it is a common practice to provide a housing with an inlet for the unfiltered liquid, an outlet for the filtered liquid and a filter layer between the inlet and the outlet to retain the contaminant in the liquid. Further, in some instances or applications, there may be a need to provide a means for supporting and/or retaining the filter layer during flow conditions.

A need exists for a filtering system that is efficient and effective. Furthermore, it is desirable that the filtering system at the same time, be constructed of such materials that it is relatively inexpensive to manufacture, and such that maintenance in operation is relatively low.

It is an object of the present invention to provide a novel approach to the task of filtering.

### SUMMARY OF THE GENERAL INVENTIVE CONCEPT

In one exemplary embodiment, there is provided a filter unit assembly and a method for filtering flowable media comprising a filter housing for a tubular filter having an outer filtering surface and an inner filtering surface. The filter housing comprises a filter support having a first permeable support portion adapted to support the outer filtering surface, and a second permeable support portion adapted to support the inner filtering surface. The second permeable support portion is substantially concentric to, bounded by and spaced apart from the first permeable support portion and is characterized in that the second permeable support portion is configured such that the surface area of the first permeable support portion and the area second permeable support portion are substantially equal.

In an exemplary embodiment, there is provided a filter assembly comprising a housing having a first open end, a first closed end, an inlet, and an outlet; a filter support, the filter support has a first permeable support portion and a second permeable support portion nested within the first permeable support portion, the filter support is seated within the housing between the inlet and the outlet; a filter element having a second open end and a second closed end, the filter element is reversed upon itself and positioned between the first and second permeable support portions to form concentrically disposed inner and outer filtering surfaces, the first and second permeable support portions has substantially equal surface area.

In some exemplary embodiments, the filter element has substantially constant lateral dimensions between the second open end and the second closed end.

In some exemplary embodiments, the filter element is cylindrical in shape between the second open end and the second closed end.

In some exemplary embodiments, the filter element is formed from one or more blanks of filter material.

In some exemplary embodiments, the housing includes an elongate body portion with a cover portion to close the first open end.

In some exemplary embodiments, the outlet is associated with the first closed end and the inlet is associated with the cover portion.

Some exemplary embodiments, further comprise a fluid boundary member located within the housing and oriented to define a pair of fluid regions in the housing, the filter support is seated at the fluid boundary member.

In some exemplary embodiments, the fluid boundary member includes a plate portion with a first peripheral region, a passage formed therein and arranged adjacent the first peripheral region, the passage bordered by a corresponding second peripheral region, the filter support extends through a corresponding passage and engages the fluid boundary member at the second peripheral region.

In some exemplary embodiments, the filter support is removable.

In some exemplary embodiments, wherein the filter support is a basket.

In some exemplary embodiments, the filter support further comprising a lip that seats on the fluid boundary member.

In some exemplary embodiments, wherein the fluid boundary member has a recess to receive the lip.

In some exemplary embodiments, the first and/or second permeable support portion being perforated, woven, molded, punched or stretched.

In some exemplary embodiments, the filter support has an intermediate region, the first permeable support portion is affixed to the second permeable support portion at the intermediate region.

In some exemplary embodiments, the second permeable support portion has an open end through the intermediate region.

In some exemplary embodiments, the second permeable support portion has a closed or permeable end wall through the intermediate region.

In some exemplary embodiments, the first and second permeable support portions are integrally formed.

In some exemplary embodiments, the second permeable support portion is removably mounted within the first permeable support portion.

In some exemplary embodiments, the first and second permeable support portions are perforated by stamping, metal expanding, wire forming or plastic molding.

In some exemplary embodiments, the second permeable support portion has a regular or irregular undulating periphery in cross section.

In some exemplary embodiments, the second permeable support portion has an irregular or regular undulating periphery in cross section to form a plurality of lobes.

In some exemplary embodiments, the second permeable support portion includes a corrugated support surface.

In some exemplary embodiments, the filter housing has an elongate first central axis, the first and second permeable support portions is concentrically aligned with a second central axis, the second central axis is substantially aligned with the first central axis, the second permeable support portion has a plurality of corrugations, each corrugation forming a lobe with a third axis, each third axis is substantially parallel with the second central axis.

In some exemplary embodiments, the filter element has a sealing member that mates with the fluid boundary member.

In some exemplary embodiments, the filter support has a lip, the filter element having a sealing member that mates with the fluid boundary member and/or the lip.

In some exemplary embodiments, the filter support has a lip, the filter element having a sealing member that mates with the fluid boundary member and/or the lip of the filter support and/or the cover portion.

In some exemplary embodiments, the filter element has one or more raised, flush, movable and/or integral handles.

In some exemplary embodiments, the first permeable support portion has a third open end and a seating portion adjacent the third open end to sealingly engage the second open end of the filter element.

In some exemplary embodiments, the first permeable support portion has a distal end region located adjacent the intermediate region, the second permeable support portion has a third closed end, the filter element is dimensioned so that the second closed end of the filter element is positioned adjacent the third closed end.

In some exemplary embodiments, the filter support includes an annular bridging portion joining the first and second permeable support portions at the intermediate region.

In some exemplary embodiments, the second permeable support portion includes an end wall portion at the third closed end.

In some exemplary embodiments, one or both of the annular bridging portion and the end wall are permeable.

Some exemplary embodiments, further comprise a cap portion removably positioned on or fixed to the third closed end.

In some exemplary embodiments, the cap portion is permeable.

Some exemplary embodiments, further comprise one or more fixed or removable bracing portions for bracing the first support portion, the second support portion, and/or the intermediate portion against operating pressures within the housing.

In some exemplary embodiments, the bracing portions are provided by one or more annular elements placed at regular or irregular intervals along the inner periphery of the second support portion.

In some exemplary embodiments, the annular elements include rings.

In some exemplary embodiments, the filter element has a peripheral filter ring to engage the filter support, the filter support includes a first interruptive formation to be positioned adjacent the filter ring, the filter ring includes a second formation to be positioned adjacent and/or engage the first formation in a complementary fashion, the first and second formations is arranged to engage when the filter ring and filter support are in an operative fluid sealing orientation to form an effective fluid seal therebetween.

In some exemplary embodiments, the first and/or second formations are arranged so that the presence of one without the other in an operative fluid sealing orientation between the filter and filter support operationally inhibits the effective fluid seal.

In another alternative exemplary embodiment, there is provided a filter assembly comprising a housing that has a first open end, a first closed end, an inlet, and an outlet; a plurality of filter supports, each filter support has a first permeable support portion and a second permeable support portion nested within the first permeable support portion, each filter support is seated within the filter housing between the inlet and the outlet; a plurality of filter elements, each received in a corresponding filter support, each filter element has a second open end and a second closed end, each filter element is reversed upon itself and positioned between the corresponding first and second permeable support portions to form concentrically disposed inner and outer filtering surfaces, the second permeable support portion has a surface area of about equal to a surface area of the first permeable portion.

In some exemplary embodiments, each filter element has substantially constant lateral dimensions between the second open end and the second closed end.

In some exemplary embodiments, each of the filter elements is cylindrical in shape between the second open end and the second closed end.

In some exemplary embodiments, the filter housing includes an elongate body portion with a cover portion to close the open end, the outlet is associated with the first closed end and the inlet is associated with the cover portion.

Some exemplary embodiments further comprise a fluid boundary member located within the housing and oriented to define a pair of fluid regions in the housing, each filter support is seated at the fluid boundary member.

In some exemplary embodiments, the fluid boundary member includes a plate portion with a first peripheral region, a plurality of passages formed therein and arranged along the peripheral region, each passage bordered by a corresponding second peripheral region, each filter support extending through a corresponding passage and engaging the fluid boundary member at the corresponding second peripheral region.

In yet another exemplary embodiment, there is provided a retainer basket for use in a liquid filtration assembly comprising an outer permeable support portion and an inner permeable support portion, the outer permeable support portion has an outer diameter sufficient to allow the retainer basket to seat within a pressure vessel, the outer permeable support has a first operative portion of a first length dimension, the inner permeable support has a second operative portion of a second length dimension, the first and second length dimension is substantially equal, the inner permeable support portion has a surface area which is substantially equal to a surface area of the outer permeable support portion.

In yet another exemplary embodiment, there is provided a retainer support for use in a filtration assembly comprising an outer permeable support portion and an inner permeable support portion, the outer permeable support portion having an outer diameter sufficient to allow the retainer support to seat within a pressure vessel, the inner permeable support portion having a surface area which is substantially equal to a surface area of the outer permeable support portion.

In some exemplary embodiments, the outer permeable support having a first operative portion of a first length dimension, the inner permeable support having a second operative portion of a second length dimension, the first and second length dimension being substantially equal.

In some exemplary embodiments, the inner support portion is removably attached to the outer support portion.

In yet another alternative exemplary embodiment, there is provided a kit for retrofitting a retainer basket for use in a liquid filtration assembly, the retainer basket of the type having an outer permeable support portion, the kit comprising an inner permeable support portion removably positionable in the outer permeable support portion, the inner permeable support portion has an effective fluid filtering surface area which is substantially equal to an effective fluid filtering surface area of the outer permeable support portion.

In some exemplary embodiments, the inner permeable support portion removably attachable to the outer permeable support portion.

Some exemplary embodiments, further comprise a plurality of filter elements for use in the retainer basket.

Some exemplary embodiments further comprise one or more fastener elements for fastening the inner permeable support portion and/or the filter elements to the outer permeable support portion.

In another alternative exemplary embodiment, there is provided a filter assembly kit for use with a liquid filtration assembly comprising; a retainer basket, the retainer basket has a first permeable support portion and a second permeable support portion mounted within the first permeable support portion, the filter basket is operable to be seated within a liquid filtration vessel; a plurality of filter elements, each filter element has an open end and a closed end and has substantially constant lateral dimensions between the open end and the closed end, the filter element is operable to be reversed upon itself to form a concentrically disposed inner and outer filtering surfaces and to be installed in the retainer basket in order to be supported by the first and second permeable support portions, the second permeable support portion has a surface area which is substantially equal to the a surface area of a first permeable support portion.

In still another alternative exemplary embodiment, there is provided a filter assembly comprising; a housing has an open end, a closed end, an inlet, an outlet, and a support portion, the support portion has a first permeable support portion and a second permeable support portion mounted within the first permeable support portion, the support portion is seated within the housing, a collapsible filter bag has a second open end and a second closed end and reversed upon itself to form a concentrically disposed inner and outer filtering surfaces is supported by the first and second permeable support portions, the second permeable support portion has a footprint bounded by a theoretical circle of a predetermined circumference, the second permeable support portion has a plurality of irregular or regular formations that provide the second permeable support portion with an increased circumference beyond that of the circumference of the theoretical circle, so that the circumference of the second permeable support portion is substantially equal to the circumference of the first permeable support portion.

In still yet another alternative exemplary embodiment, there is provided a filter assembly comprising; a housing has an open end, a closed end, an inlet, an outlet, and a support portion, the support portion has a first permeable support portion and a second permeable support portion mounted within the first permeable support portion, the support portion is seated within the housing, a collapsible filter bag has a second open end and a second closed end and reversed upon itself to form a concentrically disposed inner and outer filtering surfaces being supported by the first and second permeable support portions, the second permeable support portion has a footprint bounded by a theoretical circle of a predetermined circumference, the second permeable support portion has a plurality of irregular or regular formations that provide the second permeable support portion with an increased surface area per unit length, beyond that of the surface area of the theoretical circle per unit length, so that the surface area per unit length of the second permeable support portion is substantially equal to the surface area per unit length of the first permeable support portion.

In another alternative exemplary embodiment, there is provided a filter assembly comprising a housing has an open end, a closed end, an inlet, an outlet, and a support portion, the support portion has a first permeable support portion and a second permeable support portion mounted within the first permeable support portion and is seated within the housing, a cylindrical collapsible filter bag has a body with a second open end and a second closed end, the body has a substantially constant diameter between the second open end and the second closed end, the body is reversed upon itself to form a concentrically disposed inner and outer filtering surfaces to be supported in an operative position by the first and second permeable support portions, the first permeable support portion is cylindrical and has a first inner surface with a first circumference which is configured not to exceed the circumference of the filter bag, the second permeable support portion has a plurality of regular or irregular elongate projections distributed laterally therealong to provide a second circumference that is at most equal to the circumference of the filter element, the filter element has a first cylindrical portion so that, under predefined operating conditions, substantially all of the first cylindrical portion that is aligned with the first support is directly supported by the first support portion and a second cylindrical portion so that, under predefined operating conditions, substantially all of the second cylindrical portion that is aligned with the second support portion is directly supported by the second support portion.

In some exemplary embodiments, the filter support has an intermediate region, the first permeable support portion is affixed to the second permeable support portion at the intermediate region, the filter element includes a bridging portion between the first and second cylindrical portions, so that, under predefined operating conditions, the bridging portion is directly supported by the intermediate portion.

In some exemplary embodiments, the second permeable support portion is corrugated.

Some exemplary embodiments further comprise a cap portion removably positioned or fixed at the third closed end.

In some exemplary embodiments, the cap portion includes a plurality of ridges extending radially there along, each to align with a corresponding formation.

In some exemplary embodiments, the cap portion is permeable.

In yet another alternative exemplary embodiment, there is provided a filter assembly comprising a housing that has an open end, a closed end, an inlet, an outlet, and a support portion, the support portion has a first permeable support portion and a second permeable support portion mounted within the first permeable portion and is seated within the housing, a filter element has a second open end and a second closed end reversed upon itself to form a concentrically disposed inner and outer filtering surfaces that is supported by the first and second permeable support portions, the filter element further has a sealing structure on the second open end to mate with the support portion, the second permeable support portion has plurality of lobes to increase the surface area of the inner filter surface, compared with a surface area of a theoretical cylindrical surface whose circumference is coincident with an outermost limit of at least one of the lobes.

In some exemplary embodiments, the support portion includes a first ring to engage the housing to form a first sealing arrangement the filter element having a second ring to engage the first ring, the first ring has a first formation, the second ring has a second formation which is complementary to the first formation for engagement therewith, the sealing structure further comprising at least one pair of interruptive formations on the first and second rings for establishing an effective seal only when the first and second rings are employed.

In still another alternative exemplary embodiment, there is provided a filter assembly kit for use with a liquid filtration assembly comprising, a retainer basket, the retainer basket has a first permeable support portion and a second permeable support portion the second permeable support portion mounted within the first permeable support portion and is seated within a liquid filtration vessel, a permeable nose cap seated on the second permeable support portion, a plurality of filter elements, each filter element has a second open end and a second closed end and reversed upon itself to form a concentrically disposed inner and outer filtering surfaces being supported by the first and second permeable support portions, the second permeable support portion has a surface area substantially equal to a corresponding surface area of the first permeable portion.

In another alternative exemplary embodiment, there is provided a method of filtering a liquid comprising: providing a liquid to be delivered to a filter assembly, the filter assembly has a housing with a first open end; a first closed end; an inlet for introducing the liquid and an outlet for a filtered liquid to exit; providing a filter support, the filter support has a first permeable support portion and a second permeable support portion mounted within the first permeable portion, the filter support being seated within the housing between the inlet and the outlet; and providing a filter element that has a second open end and a second closed end reversed upon itself and positioned between the first and second permeable support portions to form concentrically disposed inner and outer filtering surfaces, the second permeable support portion has a surface area of about equal to a surface area of the first permeable portion.

In yet another alternative exemplary embodiment, there is provided a method of improving a filter operation, comprising: providing a filter assembly with a fluid inlet and a fluid outlet; locating in the filter assembly a filter support with an outer support portion and an inner support portion concentrically located within the outer support portion; providing a filter element with a substantially constant lateral dimension extending along its length between an open end to be adjacent the fluid inlet and a closed end, so that a first half adjacent the open end lies against the outer support portion and a second half adjacent the closed end lies against the inner support portion; and configuring the inner support and outer support portions with substantially equal surface areas.

In still another alternative exemplary embodiment, there is provided a method of improving a filter operation, comprising: providing a filter assembly with a fluid inlet and a fluid outlet; locating in the filter assembly a filter support with an outer support portion and an inner support portion concentrically located within the outer support portion; configuring the inner support and outer support portions with substantially equal surface areas, providing a filter element with a substantially constant lateral dimension extending along its length between an open end a closed end, with a first half adjacent the open end and a second half adjacent the closed end; and installing the filter element so that the first half lies against the outer support portion and the second half lies against the inner support portion.

In another exemplary embodiment, there is provided a filter housing for a tubular filter having an outer filtering surface and an inner filtering surface, the filter housing comprising: a filter support having a first permeable support portion adapted to support the outer filtering surface, and a second permeable support portion adapted to support the inner filtering surface; the second permeable support portion being substantially concentric to, bounded by and spaced apart from the first permeable support portion, the second permeable support portion being configured such that the surface area of the first permeable support portion and the area second permeable support portion are substantially equal.

### BRIEF DESCRIPTION OF THE DRAWINGS

Several exemplary embodiments of the present invention will now be described, by way of example only, with reference to the appended drawings in which:

FIG. 1 is a sectional view of a filter unit for industrial operations;

FIG. 2 is a top view of alternatives of a filter support;

FIG. 3 is a fragmentary perspective view of the a filter support in the unit of FIG. 1;

FIG. 4 is a cross sectional view of a filter element and the filter support of FIG. 3 in different operative orientations;

FIG. 5 is a cross sectional view of several alternatives of a sealing member and the filter support;

FIG. 6 is a fragmentary perspective view of another filter support;

FIG. 7 is a cross sectional view of a yet another filter support;

FIG. 8 is a fragmentary cross sectional view still another filter element and filter support;

FIG. 9 is an alternative filter unit for industrial operations;

FIG. 10 is a perspective view of a filter kit; and

FIG. 11 is a perspective view of an alternative filter kit.

### DETAILED DESCRIPTION OF THE EXEMPLARY EMBODIMENTS

It should be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Furthermore, and as described in subsequent paragraphs, the specific mechanical configurations illustrated in the drawings are intended to exemplify embodiments of the invention. However, other alternative mechanical configurations are possible which are considered to be within the teachings of the instant disclosure. Furthermore, unless otherwise indicated, the term “or” is to be considered inclusive.

As used herein, the term “flowable media” is used to define an intervening substance having fluid characteristics in which undesired contaminants or particulate may be carried. For example, a “flowable media” as used herein may include a fluid, a liquid, a gas, or any fluid media which may carry or contain separatable contaminants or particulate. For these purposes, the terms fluid, liquid and flowable media are herein used interchangeably.

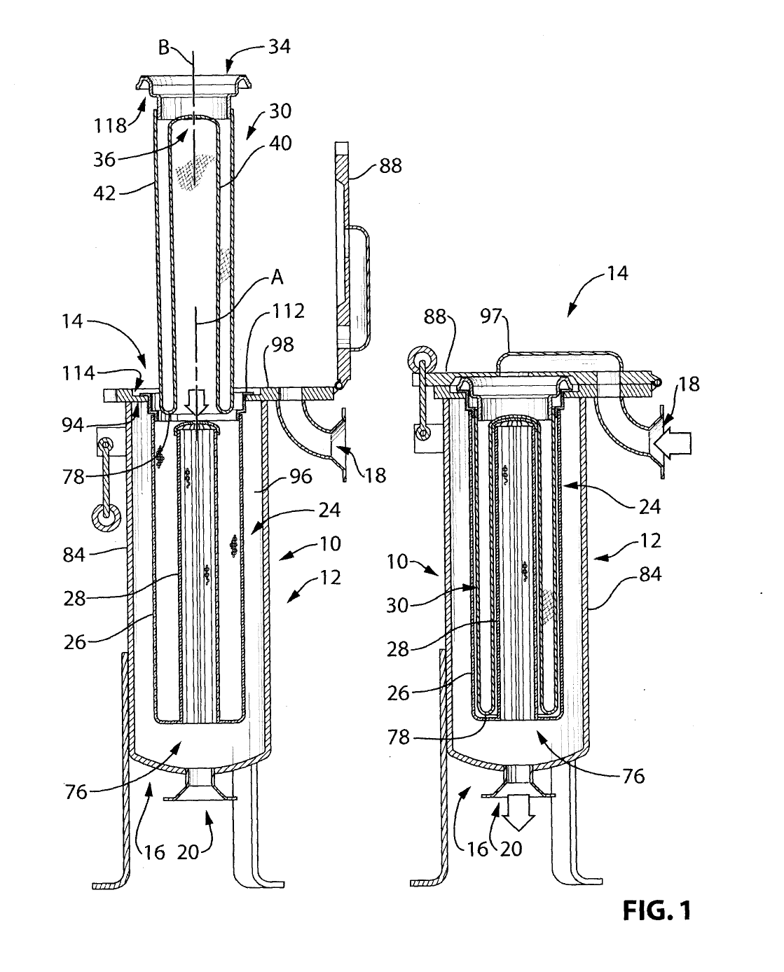

Referring to FIG. 1, there is provided a filter assembly for filtering flowable media, shown at 10. The filter assembly 10 has a housing 12 with a first open end 14, a first closed end 16, an inlet 18, and an outlet 20. Other configurations of housings may be used as desired. The filter assembly 10 has a filter support 24 with a first permeable support portion 26 and a second permeable support portion 28 nested within the first permeable support portion 26. The filter support 24 is seated within the housing 12 between the inlet 18 and the outlet 20 and further includes a filter element 30 that has a second open end 34 and a second closed end 36. The filter element 30 is reversed upon itself and positioned between the first and second permeable support portions 26 and 28 to form concentrically disposed inner and outer filtering surfaces 40 and 42.

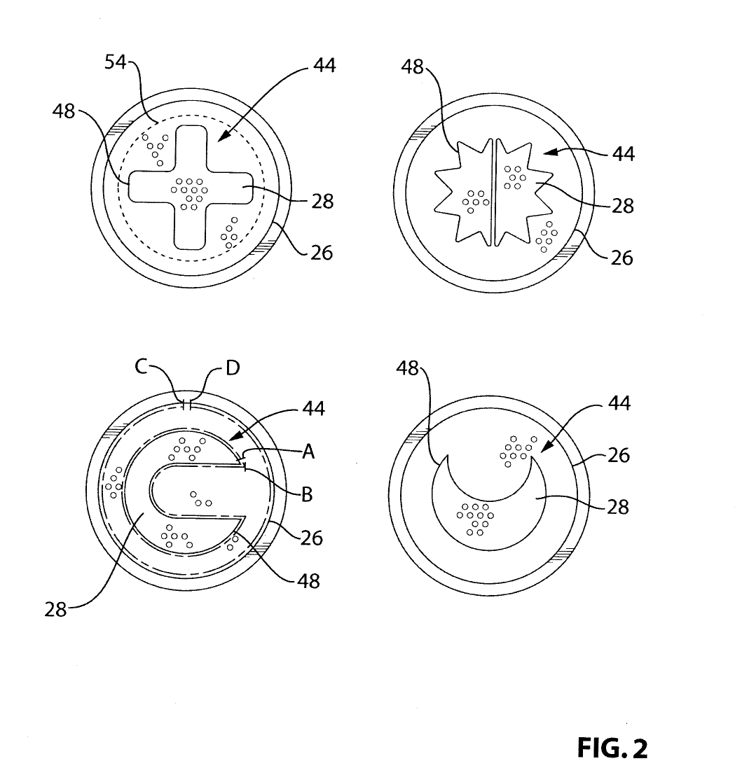

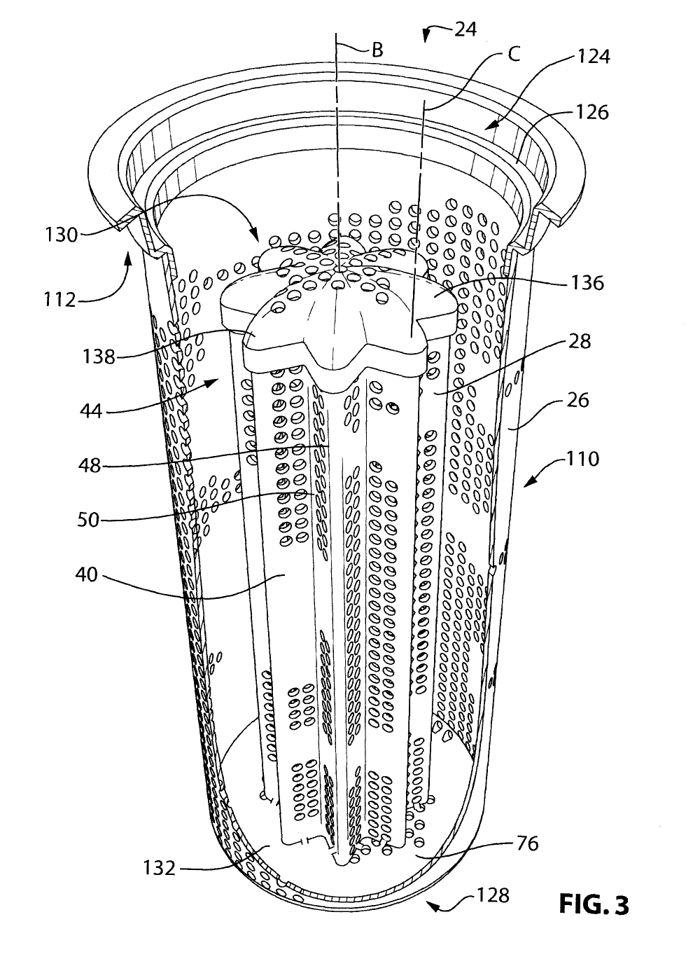

As shown in FIG. 3, the second permeable support portion 28 has a surface area which is substantially equal to a surface area of the first permeable support portion 26. The second permeable support portion 28 has a regular undulating periphery 44 in cross section to form a plurality of lobes 48. Alternatively, the periphery may also be an irregular undulating periphery. In this case, the presence of the lobes 48 on the second permeable support portion 28 has the effect of providing a corrugated support surface 50. This may be achieved by the second permeable support portion 28 being corrugated in cross section therefore providing an increase surface area (as compared with an equivalent surface area had the second permeable support portion not been corrugated in this manner). As shown in FIG. 2, other shapes and/or configurations may be used to similarly increase the surface area of the second permeable support portion 28, for example star, crescent or cruciform shapes. Also, as illustrated in FIG. 2, the inner permeable support portion may be configured from a single structure or from a plurality of structures or layers.

Further, as shown in FIG. 2, the second permeable support portion may be seen to have a footprint bounded by a theoretical circle 54 of a predetermined circumference. In this case, the second permeable support portion 28 has a plurality of regular formations that provides an increased circumference of the second permeable support 28 beyond that of the circumference of the theoretical circle 54, so that the circumference of the second permeable support portion 28 is substantially equal to the circumference of the first permeable support portion 26. In this case (referring to FIG. 2) the term circumference is intended to mean the length of a trace starting at A and ending at B along the laterally outward surface of the second support portion 28 and from C to D along the laterally inward surface of the first support portion 26.

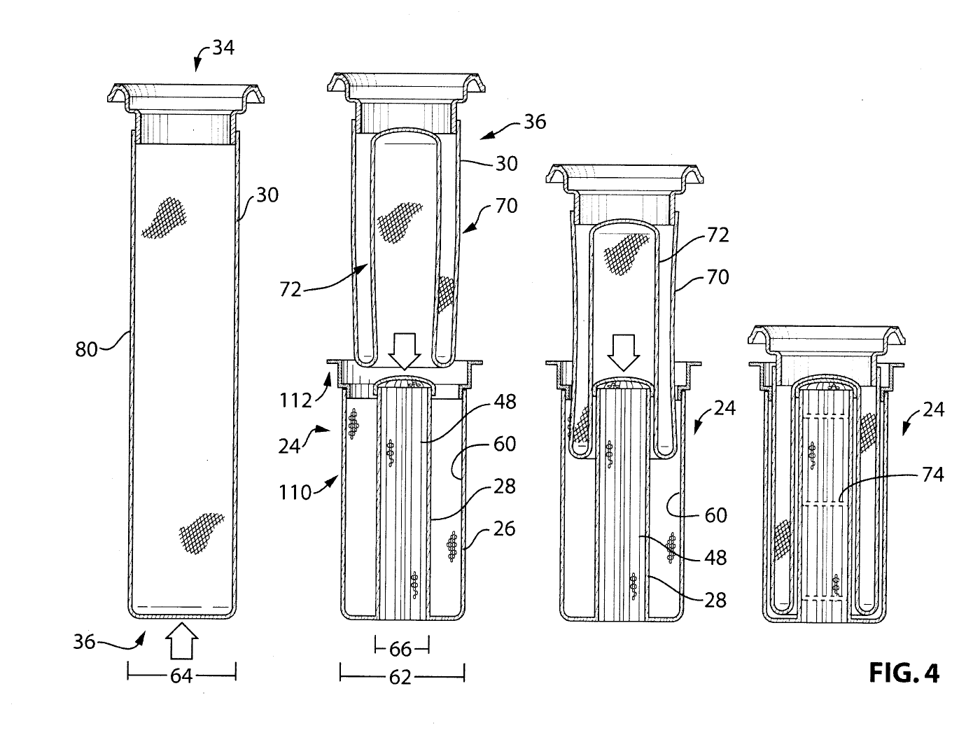

As can be seen in FIG. 4, the first permeable support portion 24 is cylindrical and has a first inner surface 60 with a first circumference 62 which is configured to be approximately equal to but not substantially exceeding a circumference 64 of the filter element. The lobes 48 on the second permeable support portion 28 provide a plurality of regular elongate projections distributed laterally therealong to provide a second circumference 66 that in one example is at most equal to the circumference 64 of the filter element 30. As can be seen in FIG. 4, the filter element 30 has a first cylindrical portion 70 to engage the first permeable support portion 26 and a second cylindrical portion 72 to engage the second support portion 28. In one example, the first and second support portions 26 and 28 are arranged to receive and support the first and second cylindrical portions 70 and 72, so that the filter material itself has minimal, if any, folds, where the filter material is lying on other filter material. Rather, in one example, substantially all of the filter material that is neighbouring the first and second support portions is contacting the first and second support portions directly. The first and second filtering surfaces are thus arranged to receive the first and second cylindrical portions in a substantially continuous basis along their respective peripheries and lengths with no substantially excess material of the filter element 30. Thus, in use, local regions of the filter element in this example and under typical operating conditions, including for example flow, pressure and the like will assume the shape of the local support provided by the corresponding support portion. In other words, the second cylindrical portion 72 will assume a pleated configuration corresponding with the configuration of the lobes of the inner surface portion while the first cylindrical portion and the bridging portion will assume the configuration of the corresponding outer surface, and intermediate portions, as well as the cap portion.

The first and second permeable support portion 26 and 28 may be perforated, woven, molded, punched, or stretched. In this example, as shown in FIG. 3 the first and second permeable support portions 26 and 28 are perforated. This perforation may be provided by stamping, metal expanding step, wire forming or plastic molding steps. In another example, one or the other of the first permeable support portion and second support portion 26 and 28 is perforated.

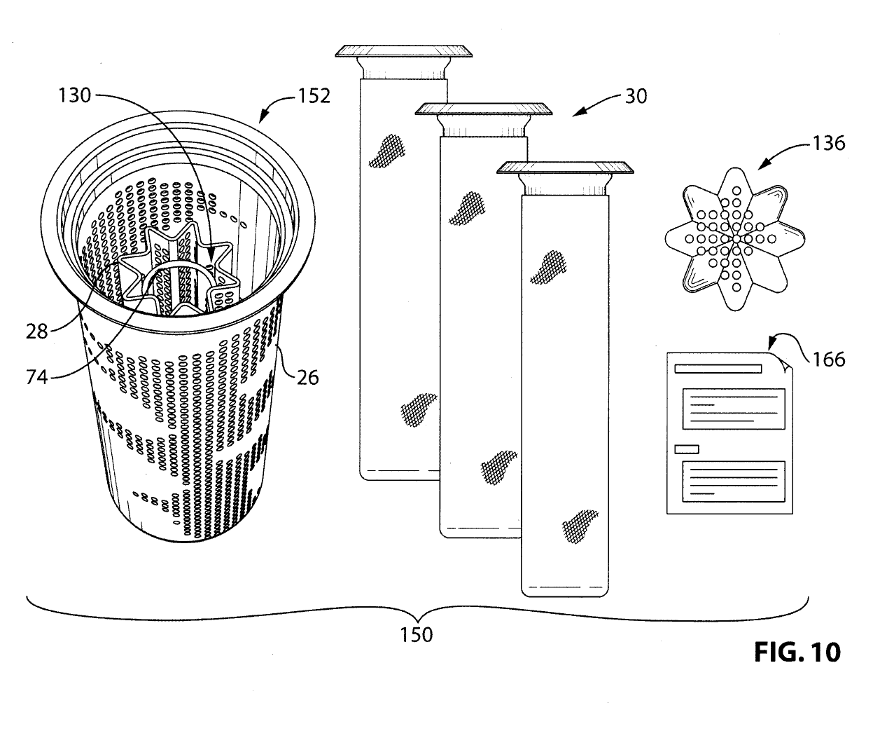

In some applications, it may be beneficial to provide one or more fixed or removable bracing portions for bracing the first support portion, the second support portion, and/or the intermediate portion against operating pressures within the housing. In one example, this may be provided by one or more fixed or removable bracing portions as illustrated in FIGS. 4 and 10 at 74. In one specific example, it may be useful to provide three or four rings welded at intervals of six inches or so, for an assembly using the housing part no FSTB1121F26150 commercially available from INDUSTRIAL FILTER MANUFACTURING LIMITED. If desired other bracing structures may be included on, above or below the intermediate portion, as well as the first support portion.

As shown in FIG. 3, the filter support 24 has an intermediate region 76 and the first permeable support portion 26 is affixed to the second permeable support portion 28 at the intermediate region 76. In this example, the first and second permeable support portions 26 and 28 are welded together but may be integrally formed with the intermediate region 76, as desired. Further, the intermediate region may be provided in other forms to provide an interconnection between the first and second permeable support portions. For instance, the intermediate region 76 may be v-shaped or u-shaped in cross section and may be of relatively small in lateral dimension depending on the desired spacing between the first and second permeable support portions. It may also be, in some applications, beneficial to provide additional bracing on the intermediate region 76, between the inner and outer support portions. In some cases it may be intersecting rod or rods connecting the bottom of the outer support portion to the inner support portion.

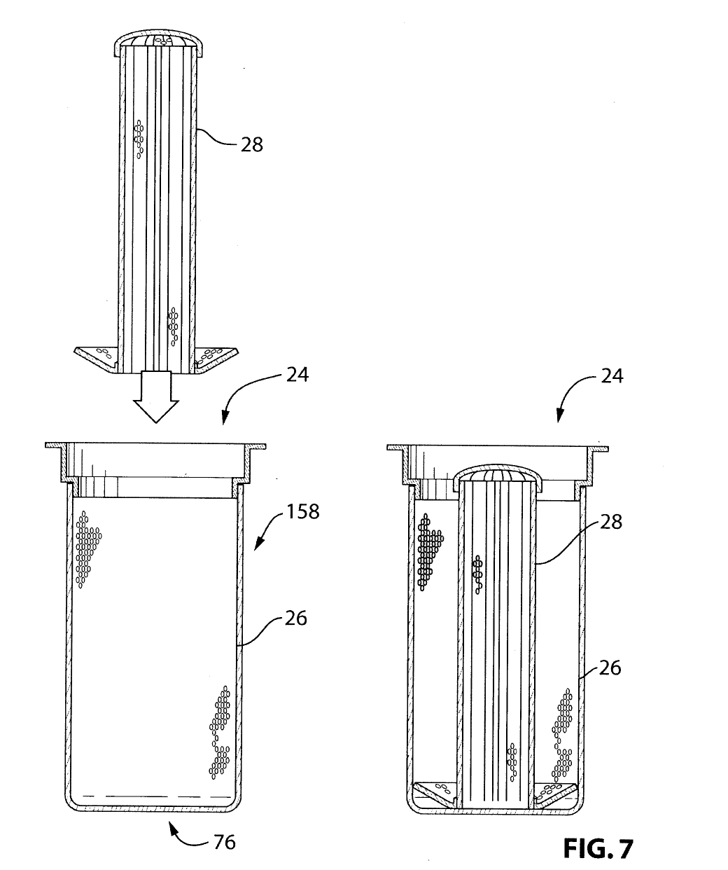

As can be seen in FIG. 1, the second permeable support portion has an open end through the intermediate region to reduce flow restriction, though there may be cases in which a closed end is arranged for other reasons, such as for additional structural reinforcement. For example, in FIG. 7, the second permeable support portion is shown with a closed or permeable end wall through the intermediate region. Further, it can be seen in FIG. 1 that the filter element includes a bridging portion 78 between the first and second cylindrical portions, so that, under predefined operating pressures, the bridging portion 78 is directly supported by the intermediate portion 76. In another example, the second permeable support portion 28 is removably mounted within the first permeable support portion 26 as illustrated in FIG. 7. This allows an existing first support portion 26 to be retrofitted with a second permeable support portion 28.

As seen in FIG. 4, the filter element 30 is cylindrical in shape between the second open end 34 and the second closed end 36. The filter element 30 can be considered collapsible or deformable and has substantially constant lateral dimensions between the second open 34 end and the second closed end 36. In this example, the filter element is made of a single blank 80 of material formed by welding or other methods, but also may be seamless. Other configurations and assembly of such material or materials may be used as desired, such as those configured from multiple blanks of varying materials and including materials with the ability to expand and/or from a stored, packaged or other pre-operative configuration. This may provide the benefit of utilizing a filter element whose circumference is less than the first and second support portions in some cases.

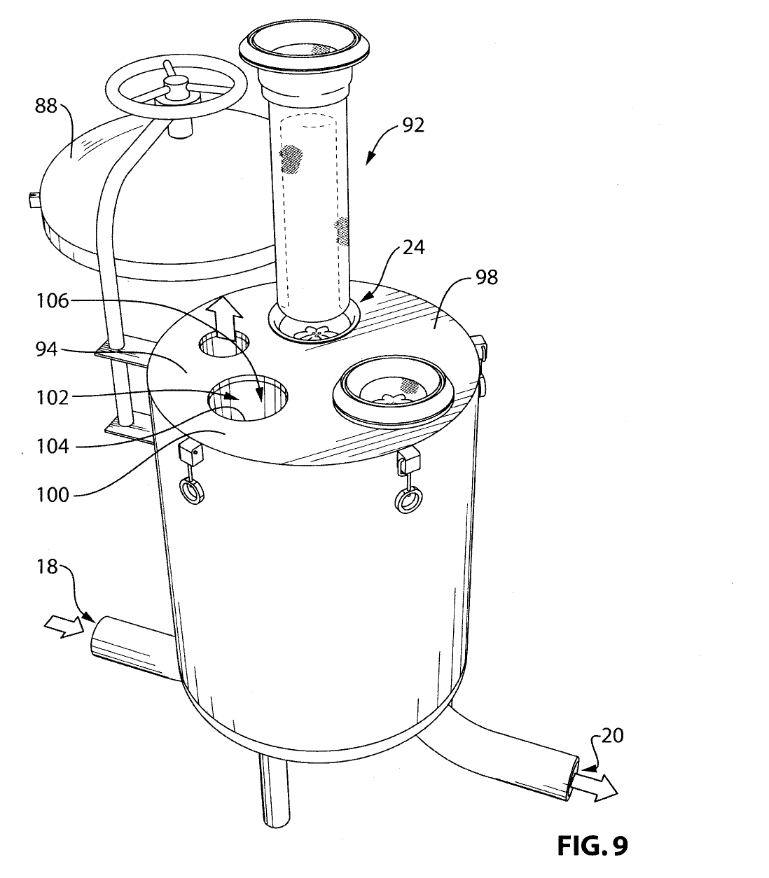

As shown in FIG. 1, the housing 10 includes an elongate body portion 84 with a cover portion 88 to close the open end 14. The outlet 20 in this example is associated with the closed end 16 and the inlet 18 is associated with the cover portion 88. Another example of the housing is shown in FIG. 9, which includes a plurality of filter elements as shown at 92.

In the example of FIG. 1, the second support portion 28 has a vertical height equal to or less than that of the first support portion 26. Other configurations may be used, for example the second support portion 28 may be higher than that of the first support portion 26, provided there is sufficient room in the housing 10 to accommodate the second support portion projecting above the first support portion. In some filter assemblies, such as that shown in FIG. 9, the cover portion 88 is convex and there may be room to have a second support portion with a height exceeding that of the first support portion. In some cases, the second support portion may have a circumference that exceeds that of the first support portion while not substantially exceeding the circumference of the second cylindrical portion of the filter element, though this may require some residual folding of the first cylindrical portion of the filter element or expanding the circumference of the first support portion.

Now referring to FIG. 1, a fluid boundary member 94 is located within the housing 12 and is oriented to define a pair of fluid regions 96, 97 therein. The filter support 24 is seated at the fluid boundary member 94.

Referring to FIG. 9, the fluid boundary member is also shown at 94 and includes a plate portion 98 with a first peripheral region 100, and a passage 102 formed therein and arranged adjacent the first peripheral region 100. The passage 102 is bordered by a corresponding second peripheral region 104 and the filter support 24 extends through a corresponding passage 106 and engages the fluid boundary member 94 at the second peripheral region 104.

Now referring to the FIGS. 1, 3 and 4, the filter support 24, in this case, is provided as a removable basket 110, with a lip 112 to seat on the fluid boundary member 94. The fluid boundary member 94, in this case, includes a recess 114 to receive the lip 112 as shown in FIG. 1.

As shown in FIG. 1, the filter housing 12 has an elongate first central axis A and the first and second permeable support portions are concentrically aligned with a second central axis B. The second central axis B, in this case, substantially aligned with the first central axis A. The second permeable support portion has plurality of corrugations, each corrugation forming one of the lobes with a third axis C. Each third axis C, in this case, is substantially aligned with the second central axis B.

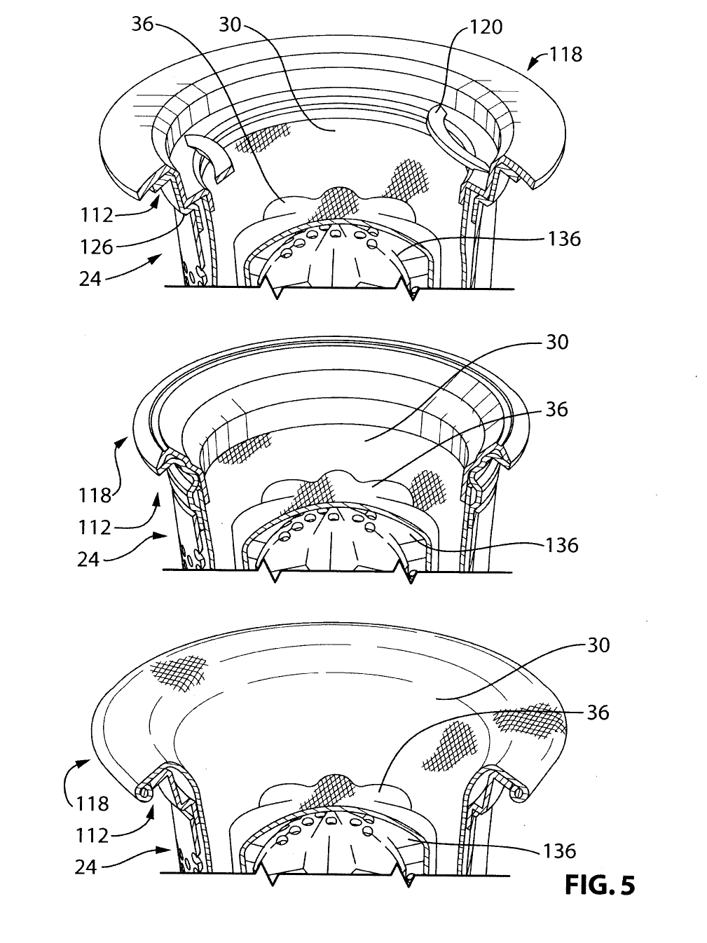

Now referring to FIG. 1, the filter element 30 has a sealing member 118 that mates with the fluid boundary member 94. In another example, the filter element's sealing member 118 may mate with the fluid boundary member 94 and/or the lip 112 of the filter support 24 as shown in FIG. 5. In yet another example, the filter element's sealing member 118 may mate with the fluid boundary member 94, the lip 112 of the filter support 24 and the cover portion 88. The filter element 30 may have one or more raised, flush, movable and/or integral handles 120 to assist in removal of the filter element 30.

As shown in FIGS. 3 and 5, the first permeable support portion 26 has a third open end 124 and a seating portion 126 adjacent the third open end 124 to sealingly engage the second open end of the filter element. The first permeable support portion 26 has a distal end region 128 located adjacent the intermediate region 76. The second permeable support portion 28 has a third closed end 130 and the filter element 30 is dimensioned so that the second closed end 36 of the filter element is positioned adjacent the third closed end 130.

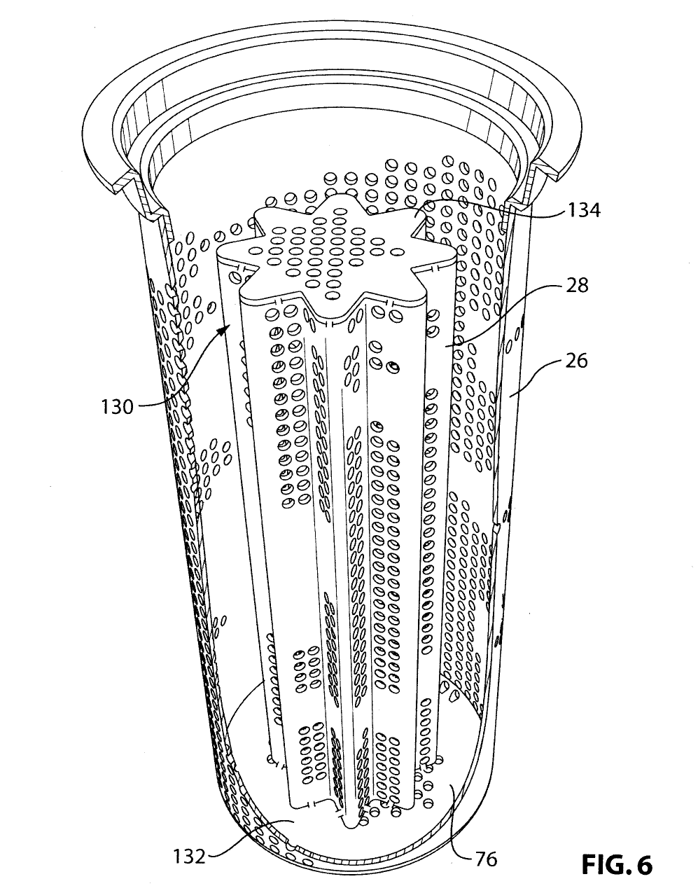

In this example shown in FIG. 6, the filter support 24 includes an annular bridging portion 132 joining the first and second permeable support portions 26 and 28 at the intermediate region 76. The second permeable support portion 28 includes an end wall portion 134 at the third closed end 130. One or both of the annular bridging portion 132 and the end wall 134 are permeable.

As shown in FIG. 3 a cap portion 136 is removably positioned or fixed at the third end 130, which in this case may be open or closed. In this example the cap portion 136 is permeable, by way of passages formed through a molded element. However, the cap portion may be made permeable with other materials or methods such as by, perforating, weaving, punching or stretching. However, in other cases, the cap portion may be utilized without being permeable. The cap portion 136 further comprises a plurality of ridges 138 extending radially outwardly from a central region thereof, each to align with a corresponding formation in the second permeable support portion 28.

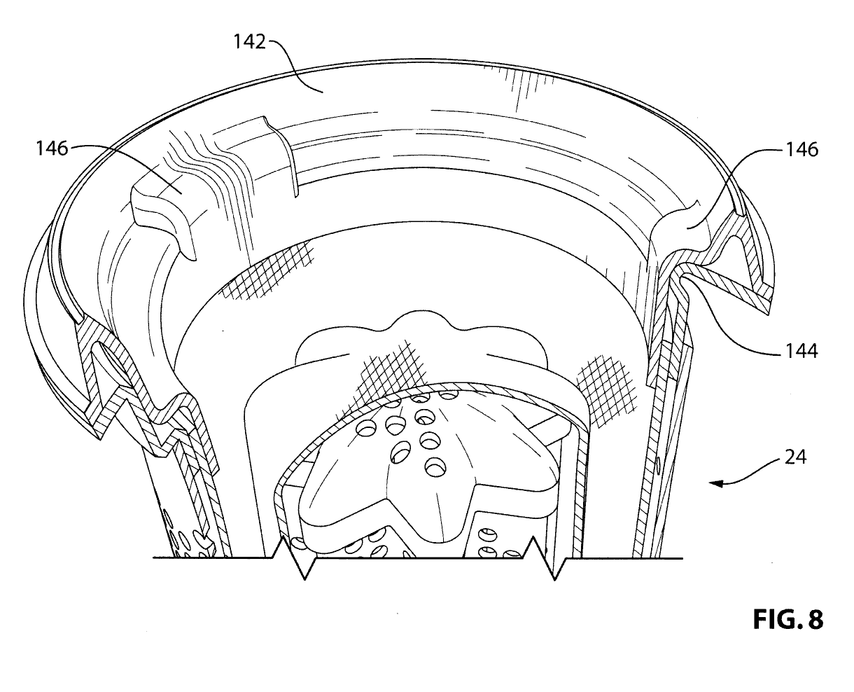

As shown in FIG. 8, in another example, the filter assembly has a peripheral filter ring 142 to engage the filter support 24, the filter support includes a first interruptive formation 144 to be positioned adjacent the filter ring 142. The filter ring 142 includes a second formation 146 to be positioned adjacent and/or engage the first formation 144 in a complementary fashion, the first and second formations 144 and 146 being arranged to engage when the filter ring 142 and filter support 24 are in an operative fluid sealing orientation to form an effective fluid seal therebetween.

The first and/or second formations 144 and 146 are arranged so that the presence of one without the other in an operative sealing orientation between the filter and filter support operationally inhibits (or results in a lack of), the effective seal and allows fluid to be passed without being filtered.

As shown in FIG. 10 there is a kit 150 for use with a liquid filtration assembly such as that shown in FIG. 1 that may include at least one retainer basket 152 and at least one cap portion 136, for each of the retainer baskets. The retainer basket 152 has a first permeable support portion 26 and a second permeable support portion 28 mounted within the first permeable support portion 26. The cap portion 136 may be removably positioned or fixed at the third end 130 of the second permeable support portion 28. The filter basket 152 is operable to be seated within a liquid filtration vessel. A plurality of filter elements 30 are also provided for use in the permeable retainer basket 152. A set of instructions for the use of the kit are also provided at 166.

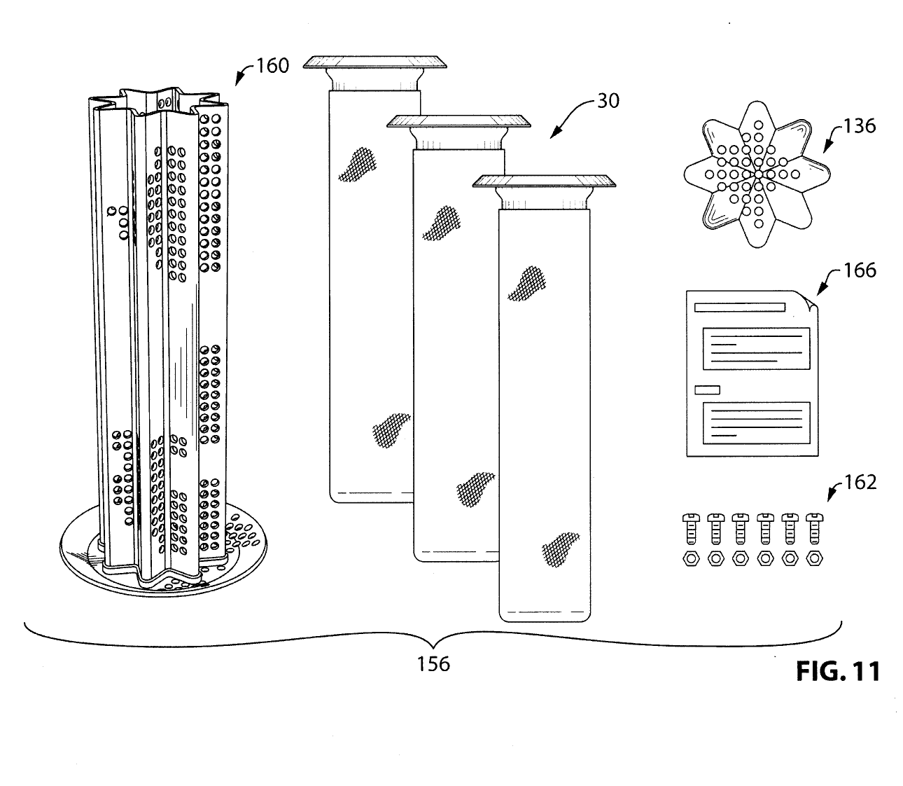

As shown in FIG. 11 there is a second kit 156 for retrofitting a permeable retainer basket, such as that shown at 158 in FIG. 7 for use in a liquid filtration assembly. The kit comprises an inner permeable support portion 160 that is removably positionable in the permeable retainer basket. At least one cap portion 136 is removably positioned or fixed at the third end of the inner permeable support portion 160. A plurality of filter elements 30 are also provided for use in the permeable retainer basket following installation of the inner permeable support portion. There may require one or more fastener elements 162 or alternate fastening device or method for fastening the inner permeable support portion 160 to the outer permeable retainer basket 158. A set of instructions for the use of the kit are also provided at 166.

Now, with reference to FIG. 1, the assembly 10 may be used in the following manner. First, the user assembles the filtering assembly by ensuring the filter housing is in a non-pressurized state in accordance with safe operating procedures. The user then opens the cover portion 88 of the housing as shown in FIG. 1. The user identifies the filter support with the first permeable support portion and a second permeable support portion mounted within the first permeable support portion. In some cases it may be desirable to remove the filter support. The user takes the filter element that has a second open end and a second closed end and then reverses it upon itself. In some cases, the filter element may also be provided in the reversed position as shown in FIG. 1. The filter element is then positioned between the first and second permeable support portions to form concentrically disposed inner and outer filtering surfaces. The user may wish to use a tool to assist the insertion of the filter element and furthermore enhance the relative association in proximity of the element to the support structure, such as the tool commercially available from INDUSTRIAL FILTER MANUFACTURING LIMITED under part number FS1003.

The user then closes the cover portion and secures the cover in accordance with safe operating procedures and delivers unfiltered liquid under predefined operating pressure and/or conditions to the filter assembly through the inlet in the open end of the housing. As the unfiltered liquid enters the housing the filter element is supported continuously by the first permeable support portion, the second permeable support portion, the intermediate portion and the cap portion. The pressurized unfiltered liquid passes through the filter element leaving particulates on or in the filter element and cleans the liquid that will exit an outlet in the closed end of the housing. The filter element continues to be supported throughout the fluid filtering process to a determined point of pressure and contamination capacity of the support structure under predefined operating conditions.

Thus, it can be said that there is a relationship between the support portion and the filter element, in particular between the second support portion and the circumference of the filter element. If the circumference of the filter is too small there may be a risk that the second support portion will not sufficiently support the filter element and there may be a chance of damage to the filter element. Conversely if there is too much material there may be excessive overlapping of portions of the filter media leaving material folding over on itself and may result in correspondingly reduced efficiency.

Liquid or fluid filtration involves the removal of contaminant particles in a fluid system. The grade of filter element chosen for a specific application is usually determined by the size of the particle to be removed. Contaminant particles are measured using the “micron” unit of measurement. Particle size retention, dirt holding capacity, filtration efficiency and differential pressure are aspects to consider when choosing the filter medium.

Thus, in some examples, the second support member may provide equivalent surface area to the first support portion to support a filter bag of consistent diameter, but with the second support member being located within a relatively smaller operating diameter, as provided by the lobed, or other undulating wall configuration. This may allow, in some cases, one or more of the following:
increased fluid flow rate capacity through the filter bag.
increased dirt-holding capacity within the filter bag;
reduced clean differential pressure drop across the filter bag;
capacity for higher viscosity of fluid processed through the filter bag;
ability to constrict the filter porosity for greater efficiency or smaller particulate retention;
longer service life or reduction in filter bag change out frequency;
reduced interference with the fluid flow that decreases “down time” and maintenance attention; and reduced costs associated with the use of a filter bag system.

In some examples, the filter unit may provide a filter bag which is primarily a tubular structure of extended length. The filter bag is made up of a continuous and constant diameter tube of varying types of material. The material may be a polypropylene or polyester needled felt that is thermally bonded. However, the filter bag may be made from mesh type material, multi-layer or high efficiency configurations, or any number of other flexible porous filter materials. The seams may also be sealed with stitching or other forms of seam fastening methods. The bag may be sealed at one end along the width of the tube, perpendicular to the long side seam, collapsing the tube into a flat conclusion. The opposite end may be fastened to a ring or plastic flange top, causing the top of the bag to be forced open, taking the shape of the top retainer. The tube making up the body of the filter bag may be longer than a standard filter bag. However, the final manufacturing process used may shorten the length of the bag with the reversal of the bottom section. The bag is upturned within itself so the bottom portion is aligned with the inside walls of the top portion. There is a seamless fold connecting the two portions. This makes a finished bag with similar length and diameter of a conventional filter bag. The manufacturing process may then utilize a semi or fully automated process for precise finished dimensions and an economical filter element.

In some examples, the filter unit may include a basket with a top lip of a dimension and construction that offers support and sealing for the basket, as it sits adjacent to the inside of the housing wall on a protrusion or ridge. Housing construction may determine the placement and sealing mechanism for this component. The top ring may also ensure an appropriate seal to the top support ring or flange fastened to the filter bag. Thus, the basket may be used to provide a “bypass free seal” ensuring all the contaminated fluid is channelled exclusively through the bag. The term “bypass free seal” is used in this case to mean that seal will minimize, if not eliminate passage of contaminated or unfiltered fluid between the support structure of the housing and the filter element, without being filtered.

In some examples, the outer sleeve portion of the basket may have a diameter and a length to follow the restrictions of the housing within which it is seated. This outer support portion of the basket is generally circular and evenly cylindrical along its length, though other configurations may also be utilized in some cases. The surface of the support basket may be provided with raising or depressing portions to create dimples or protrusions in a pattern that augment the available surface area. The outer sleeve may then be fastened to the top ring described above at one end, and the outer sleeve is furthermore fastened to an inner core by way of a support material at the opposite end to the top lip. The support media may be similar material to the outer and inner core. The material of construction chosen for the basket may be perforated stainless steel, but may also encompass a range of other materials, including those which are supportive and/or manipulated or moulded into a desired shape with a porosity significant enough for adequate fluid throughput.

In some examples, the inner core of the filter unit may be seen to expand the available surface area by occupying the cavity formed by the outer support basket wall. This void space provides residence for the supplemental internal support core. Occupying a portion of this previously void space displaces a significant portion of the dirty fluid, enabling the utilization of the unexploited region. The inner core may thus include a porous material similar to the outer basket wall and bottom union segment that has been shaped to form a lobed, pleated, or corrugated surface. The longitudinal protrusions may thus extend along the full or a partial length of the internal core, between the bottom support to the top dome shaped undulating cap. The height of the internal core relates to the height of the outer support structure such that the surface area generated by the protrusions on the core support is at least equal to the surface area of the outer support sleeve. It may be desirable in some cases to reduce the length of, or to shorten, the internal core to offer less surface area, though this may limit the effective length of the filter element that can be supported by the filter unit and thus reduce surface area.

Thus, in some examples, the filter unit may be adjusted to fit previous filter housings and provide significantly increased surface area, and in some cases as much as twice the filter surface area over other filter units. The maximization of the surface area is due, in one example, to the undulating surface of the inner core. In this case, the filter element, when in the form of a bag, may be inverted within itself is relatively economic to manufacture and relatively easy to employ. The filter unit, in an example, may be manufactured with a minimal number of seams, comparable to standard filter bags. The seams can, in some cases, be a possible source of bypass or rupture. A finished profile of the filter bag, in one example, has a dual walled construction, with the inner material sitting against the outer material. This arrangement, with the inner and outer portions of the filter bag resting against each other, provides a filter bag with a slender filter wall. There is a maximized distance between the inner dimension of the outer basket support sleeve wall, and the outermost points of the lobes, protrusions, pleats, or corrugations extending from the internal core. The arrangement of the inner core and the outer sleeve may thus allow, for example, for ample room for the filter bag to be inserted. The arrangement of the support and insertion of the filter bag imposes minimal friction and interference. In addition to the space left for the insertion of the filter bag, the inner core may be capped with a convex shaped dome.

In some examples, a dome top may be provided with a rippled surface having of a series of radiating undulations corresponding in number and aligning with similar dimension to the longitudinal protrusions travelling along the length of the inner core. A resulting wavy surface provided by these protrusions may be seen to rise to the top of the dome where the undulations shrink gradually until they disappear where they meet at a common rounded point in the centre at the top of the dome. This shape may, in one example, be desirable for some applications, since it provides an enhanced support for the filter bag due to the dome shape and wrinkled surface. The cap may also be porous, allowing for an additional filtration opportunity. Also, the undulating dome top may allow for an obtuse, smooth interface between the sides of the inner core and the upper cap, so that the filter bag may easily slide into the cavity between the inner core and outer support sleeve. The filter unit may be introduced into an existing housing providing as much as a 100 percent increase in the flow rate capacity, dirt holding capacity and general filter life, utilizing an element that is economically manufactured and relatively easily inserted into the support basket comparable to the effort required to insert a standard bag.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A filter assembly comprising a housing having a first open end, a first closed end, an inlet, and an outlet; a filter support, the filter support having a first permeable support portion and a second permeable support portion nested within the first permeable support portion, the filter support being seated within the housing between the inlet and the outlet to receive a filter element having a second open end and a second closed end and reversed upon itself and positioned between the first and second permeable support portions to form concentrically disposed inner and outer filtering surfaces, the first and second permeable support portions having substantially equal surface area.

2. An assembly as defined in claim 1, further comprising the filter element, the filter element having substantially constant lateral dimensions between the second open end and the second closed end.

3. An assembly as defined in claim 2, the filter element being cylindrical in shape between the second open end and the second closed end.

4. An assembly as defined in claim 2, the filter element being formed from one or more blanks of filter material.

5. An assembly as defined in claim 1, the housing including an elongate body portion with a cover portion to close the first open end.

6. An assembly as defined in claim 5, the outlet being associated with the first closed end and the inlet being associated with the cover portion.

7. An assembly as defined in claim 6, further comprising a fluid boundary member located within the housing and oriented to define a pair of fluid regions in the housing, the filter support being seated at the fluid boundary member.

8. An assembly as defined in claim 7, the fluid boundary member including a plate portion with a first peripheral region, a passage formed therein and arranged adjacent the first peripheral region, the passage bordered by a corresponding second peripheral region, the filter support extending through a corresponding passage and engaging the fluid boundary member at the second peripheral region.

9. An assembly as defined in claim 8, the filter support being removable.

10. An assembly as defined in claim 9, wherein the filter support is a basket.

11. An assembly as defined in claim 9, the filter support further comprising a lip that seats on the fluid boundary member.

12. An assembly as defined in claim 11, wherein the fluid boundary member has a recess to receive the lip.

13. An assembly as defined in claim 1, the first and/or second permeable support portion being perforated, woven, molded, punched or stretched.

14. An assembly as defined in claim 1, the filter support having an intermediate region, the first permeable support portion being affixed to the second permeable support portion at the intermediate region.

15. An assembly as defined in claim 14, the second permeable support portion having an open end through the intermediate region.

16. An assembly as defined in claim 14, the second permeable support portion having a closed or permeable end wall through the intermediate region.

17. An assembly as defined in claim 14, the first and second permeable support portions being integrally formed.

18. An assembly as defined in claim 14, the second permeable support portion being removably mounted within the first permeable support portion.

19. An assembly as defined in claim 18, the first and second permeable support portions being perforated by stamping, metal expanding, wire forming or plastic molding.

20-68. (canceled)
